(19) United States
(12) Patent Application Publication
(10) Pub. No.: US 2024/0351215 A1
(43) Pub. Date: Oct. 24, 2024

(54) AUTOMATIC CAR WASH SYSTEM AND METHOD THEREOF

(71) Applicant: SUNNDER TECHNOLOGY CO. LTD, NANTOU COUNTY (TW)

(72) Inventor: CHENG-HSIEN CHANG, NANTOU COUNTY (TW)

(21) Appl. No.: 18/631,619

(22) Filed: Apr. 10, 2024

(30) Foreign Application Priority Data
Apr. 21, 2023 (TW) 112114916

(51) Int. Cl. B25J 9/16; B25J 11/00; B60S 3/04; G06V 20/52; G06V 20/62

(52) U.S. Cl. CPC B25J 9/1697; B25J 11/0085; B60S 3/04; G06V 20/52; G06V 20/625; G06V 2201/08

(57) ABSTRACT

An automatic car wash system and an automatic car wash method are disclosed. A washing path is created for each of common vehicles on the market. The washing path is generated by manually pulling a washing unit to move along the contour of a vehicle, without any dead spots. When the vehicle is to be washed, the washing path corresponding to the type of the vehicle is selected, and the washing unit is driven to wash the vehicle along the washing path. The automatic car wash system can wash different vehicles fully, without dead spots, improving the cleanliness of automatic car wash greatly.

### FIELD OF THE INVENTION

The present invention relates to an automatic car wash system and a method thereof, and more particularly, to a full-time, fully automatic intelligent car wash system and a method thereof.

### BACKGROUND OF THE INVENTION

A conventional automatic car wash system usually has a car wash lane. Washing devices, such as clean water sprinklers, soapy water sprinklers, brushes, blowers/dryers, are disposed along the car wash lane for washing a vehicle passing through the car wash lane. However, this car wash system cannot be adjusted for different vehicles, resulting in incomplete washing of the vehicle. Accordingly, the inventor of the present invention has devoted himself based on his many years of practical experiences to solve these problems.

### SUMMARY OF THE INVENTION

The primary object of the present invention is to provide an automatic car wash system and a method thereof, which can adjust a washing path for each of vehicles of different types, so as to wash vehicles fully without blind spots.

According to one aspect of the present invention, an automatic car wash system is provided. The automatic car wash system comprises at least one car wash lane, a recognition unit, a positioning unit, at least one washing unit, and a control unit. The car wash lane is configured for one vehicle to pass and park. The recognition unit is located close to the car wash lane for identifying the vehicle that is going to enter the car wash lane and obtaining a vehicle feature. The positioning unit is located close to the car wash lane for locating the vehicle parked in the car wash lane to obtain parking data. The washing unit is located close to the car wash lane and has a robot arm. The robot arm has a working end equipped with a washing structure for washing the vehicle. The recognition unit, the positioning unit and the washing unit are electrically connected to the control unit. The control unit is electrically connected to a database. The control unit selectively executes a modeling process and a washing process. When the vehicle is parked in the parking area and the modeling process is selected and executed, the parking data obtained by the positioning unit is set as initial data, the washing unit is pulled manually to move along a contour of the vehicle, a movement trajectory of the washing unit is recorded to generate a washing path, and the initial data and the washing path are integrated into vehicle type information to be stored in the database. When the vehicle is parked in the parking area and the washing process is selected and executed, the vehicle feature obtained by the recognition unit is compared with the database to determine whether there is the corresponding vehicle type information in the database, if yes, the corresponding vehicle type information is read, the parking data obtained by the positioning unit is compared with the initial data of the vehicle type information to generate a compensation parameter, the washing path is adjusted based on the compensation parameter, and the washing unit is controlled to move along the adjusted washing path to wash the vehicle.

According to another aspect of the present invention, an automatic car wash method is provided. The automatic car wash method comprises the steps of: creating vehicle type information for a plurality of vehicles of different types and storing the vehicle type information in a database, wherein the vehicle type information contains initial data of the position of the vehicle parked in a car wash lane, and a washing unit is pulled manually to move along a contour of the vehicle to generate a washing path; creating a vehicle feature for each of the plurality of vehicles, wherein the vehicle feature is associated with the corresponding vehicle type information of the database; wherein when the vehicle to be washed is going to enter the car wash lane, the vehicle feature of the vehicle to be washed is obtained, and the corresponding vehicle type information is compared and read from the database through the vehicle feature; obtaining parking data of the vehicle parked in the car wash lane, comparing the parking data with the initial data of the vehicle type information to generate a compensation parameter; adjusting the washing path of the vehicle type information based on the compensation parameter, and controlling the washing unit to move along the adjusted washing path to wash the vehicle to be washed.

Thereby, the vehicle type information for each of common vehicles on the market can be created in advance and stored in the database. The user can register the vehicle feature of his/her vehicle and associate it with the corresponding vehicle type information. When the user drives the vehicle into the car wash lane, the type of the vehicle can be automatically identified and the corresponding washing path can be selected for washing the vehicle. Thus, the present invention can achieve the purpose of intelligent, manless and full-time automatic car wash and can wash any type of vehicles fully, without dead spots, improving the cleanliness of washing car greatly.

### BRIEF DESCRIPTION OF THE DRAWINGS

FIG. 1 is a perspective view according to a preferred embodiment of the present invention;

FIG. 2 is a bottom view of a washing structure according to the preferred embodiment of the present invention;

FIG. 3 is a flow chart of a modeling process according to the preferred embodiment of the present invention;

FIG. 4 is a schematic view of generating a washing path according to the preferred embodiment of the present invention;

FIG. 5 is a flow chart of a washing process according to the preferred embodiment of the present invention; and

FIG. 6 is a flow chart of an automatic car wash method according to the preferred embodiment of the present invention.

### DETAILED DESCRIPTION OF THE PREFERRED EMBODIMENTS

Embodiments of the present invention will now be described, by way of example only, with reference to the accompanying drawings.

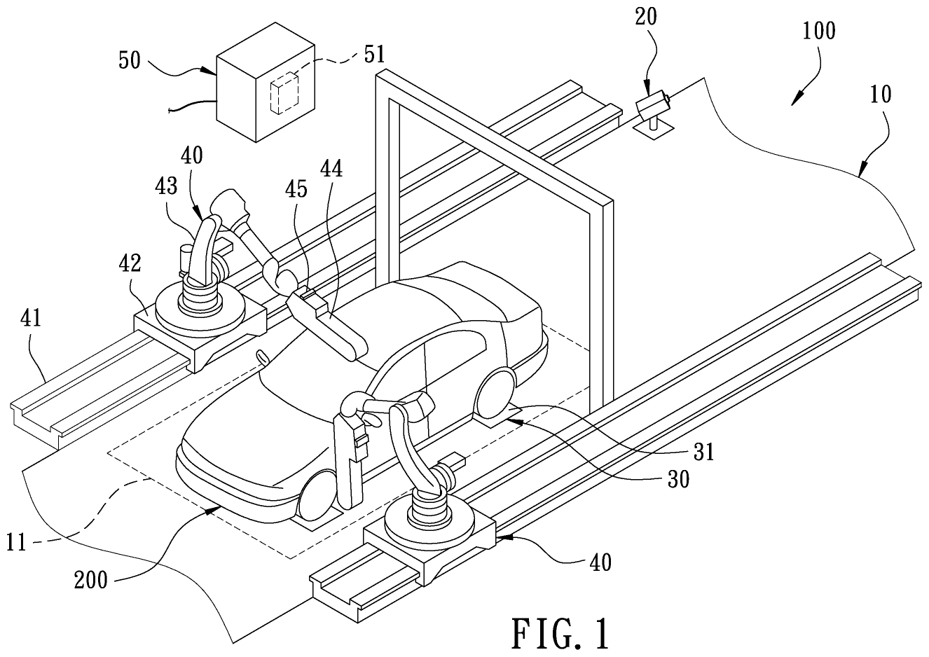

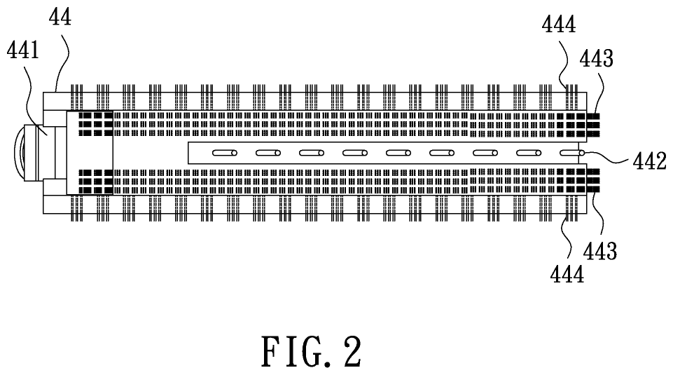

FIG. 1 is a perspective view according to a preferred embodiment of the present invention. FIG. 2 is a bottom view of the washing structure according to the preferred embodiment of the present invention. The present invention discloses an automatic car wash system 100, comprising at least one car wash lane 10, a recognition unit 20, a positioning unit 30, at least one washing unit 40, and a control unit 50.

The car wash lane 10 is configured for a vehicle 200 to pass therethrough. In this embodiment, the car wash lane 10 has a parking area 11 for the vehicle 200 to be parked there.

The recognition unit 20 is located close to the car wash lane 10 for identifying the vehicle 200 that is going to enter the car wash lane 10 and obtaining a vehicle feature. The vehicle feature is an image feature, such as the type or license plate number of the vehicle. The vehicle feature may be in other forms, such as e-tags. In this embodiment, the recognition unit 20 is a camera used for obtaining the vehicle feature by means of image recognition. The vehicle feature is the license plate number.

The positioning unit 30 is located close to the car wash lane 10 for locating the vehicle parked in the car wash lane 10 to obtain parking data. In this embodiment, the positioning unit 30 has a plurality of sensing modules 31 located in the parking area 11 for obtaining the parking data by sensing the position of the wheels of the vehicle 200. The sensing modules 31 may be contact sensors or non-contact sensors, such as proximity sensors, pressure sensors, ultrasonic sensors, or infrared sensors. It is possible to use other means of obtaining the parking data, such as image recognition.

The washing unit 40 is located close to the car wash lane 10. In this embodiment, the automatic car wash system includes a pair of washing units 40. The washing units 40 are arranged on both sides of the car wash lane 10, respectively. The washing units 40 each have a slide rail 41 arranged along the car wash lane 10. A platform 42 is slidably connected to the slide rail 41. A multi-axis movable robot arm 43 is disposed on the platform 42. The working end of the robot arm 43 is equipped with a washing structure 44 for washing the vehicle 200 and a camera module 45 for photographing the vehicle 200 to obtain a parking image. As shown in FIG. 2, the washing structure 44 has a body 441. The body 441 is substantially in a rectangular shape and has a plurality of spray holes 442 arranged along the length of the body 441 for performing washing operations, such as for spraying high-pressure clean water, soapy water, etc. The body 441 further has a plurality of movable brushes 443, 444 for brushing the surface of the vehicle 200. Preferably, the brush 443 is a belt brush that can move forward and backward along the length of the body 441, and the brush 444 is a brush wheel that can rotate clockwise and counterclockwise with the length of the body 441 as the center axis, such that the washing structure 44 can perform four-way brushing to improve the car wash effect.

The control unit 50 is electrically connected to the recognition unit 20, the positioning unit 30 and the washing unit 40. The control unit 50 is further electrically connected to a database 51. The control unit 50 has a built-in modeling process and a washing process and can selectively execute one of the modeling process and the washing process.

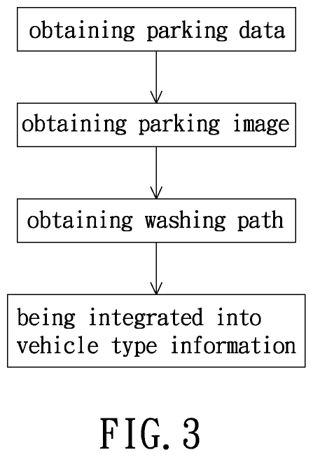

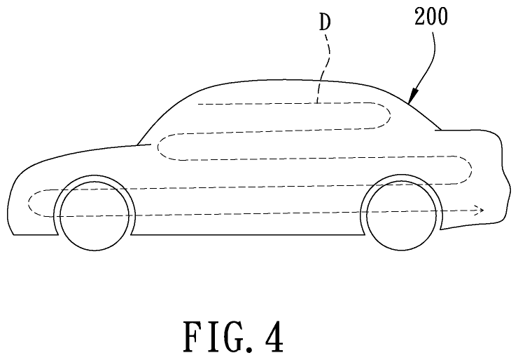

FIG. 3 is a flow chart of the modeling process according to the preferred embodiment of the present invention. FIG. 4 is a schematic view of generating a washing path according to the preferred embodiment of the present invention. When the vehicle 200 is parked in the parking area 11 and the modeling process is selected and executed, the control unit 50 sets the parking data obtained by the positioning unit 30 as initial data and sets the parking data obtained by the washing unit 40 as an initial image. As shown in FIG. 4, the washing unit 40 is pulled manually to move along the contour of the vehicle 200 for the control unit 50 to record the movement trajectory of the washing unit 40 and generate a washing path D. Then, the initial data, the initial image and the washing path D are integrated into vehicle type information to be stored in the database 51. The inventor has tried to use laser scanning to obtain the contour of the vehicle 200 for planning and generating the washing path D. However, this method is prone to create a blind scanning area and there are dead spots for washing, or it cannot get close to the contour of the vehicle because of interference. Therefore, the method that the washing unit 40 is pulled manually to move along the contour of the vehicle 200 is a preferred embodiment. In particular, the design of the robotic arm 43 allows the flexibility of the robotic arm 43 to achieve a complete fit to the contour of the vehicle.

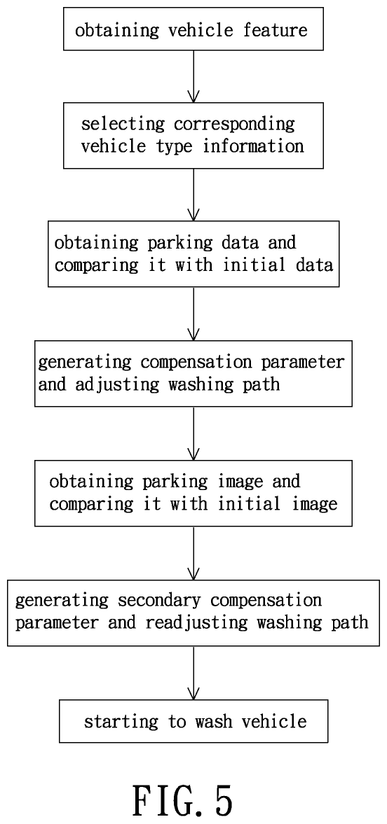

FIG. 5 is a flow chart of the washing process according to the preferred embodiment of the present invention. When the vehicle 200 is parked in the parking area 11 and the washing process is selected and executed, the control unit 50 selects the corresponding vehicle type information from the database 51 based on the vehicle feature obtained by the recognition unit 20. Preferably, the license plate number may be used as the vehicle feature, as shown in this embodiment, and the license plate number may be associated with the corresponding vehicle type information of the database 51 in advance, such that the control unit 50 can determine and select the vehicle type information based on the license plate number. After that, the control unit 50 compares the parking data obtained by the positioning unit 30 with the initial data of the vehicle type information to generate a compensation parameter, and adjusts the washing path D based on the compensation parameter. It is better to compare the parking image obtained by the washing unit 40 with the initial image to reconfirm whether there is still a deviation. If yes, image calculation is used to generate a secondary compensation parameter for the control unit 50 to adjust the washing path D again based on the secondary compensation parameter. In this way, the washing path D can be adjusted more accurately. Finally, the washing unit 40 is controlled to move along the adjusted washing path D to wash the vehicle 200.

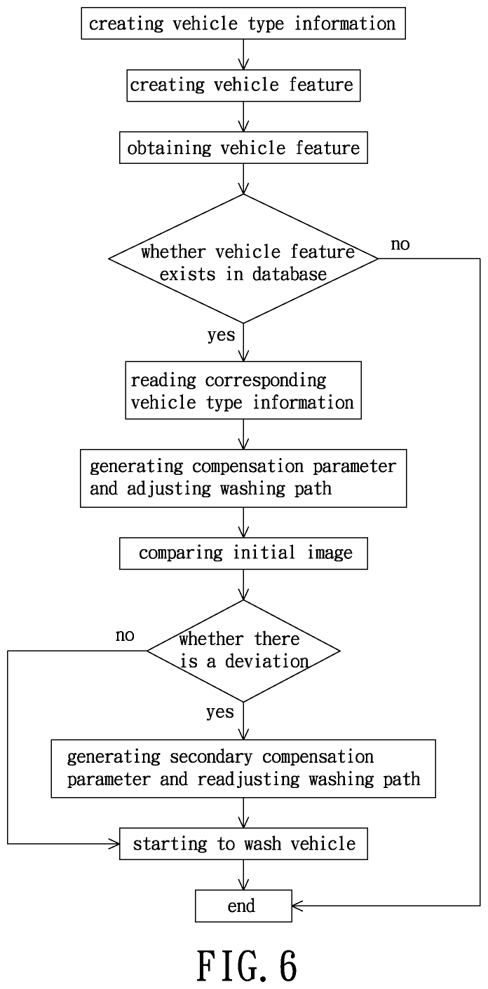

FIG. 6 is a flow chart of an automatic car wash method according to the preferred embodiment of the present invention. The present invention further discloses an automatic car wash method, which is performed using the aforementioned automatic car wash system 100 and comprises the following steps.

First, the modeling process is executed. The vehicle type information is created for a plurality of vehicles 200 of different types and stored in the database 51. Specifically, the vehicle 200 is parked in the parking area 11, and the parking area 11 may be set with reference coordinates. The positioning unit 30 is then activated to sense the position of the wheels of the vehicle 200 through the sensing modules 31, so as to obtain the parking data of the vehicle 200 parked in the parking area 11. At the same time, the washing unit 40 is moved to align the camera module 45 with a reference feature of the vehicle 200, such as the vehicle logo, headlights, handles, etc., and captures the parking image of the vehicle 200 parked in the car wash lane 11. The washing unit 40 is pulled manually to move along the contour of the vehicle 200 for the control unit 50 to record the movement trajectory of the washing unit 40 and generate the washing path D. The parking data is set as the initial data, and the parking image is set as the initial image. Then, the initial data, the initial image and the washing path D are integrated into the vehicle type information to be stored in the database 51.

The vehicle feature is then created for each of the plurality of vehicles 200. The vehicle feature is associated with the corresponding vehicle type information of the database 51. In this embodiment, the user can register the license plate number in the database 51 and associate the license plate number with the corresponding vehicle type information. If the database 51 doesn't have the vehicle type information corresponding to the vehicle type, the modeling process can be additionally executed to customize the vehicle type information for the user.

After the above preparation steps are completed, the washing process will be executed. When a vehicle 200 to be washed is going to enter the car wash lane 10, the recognition unit 20 will first obtain the vehicle feature of the vehicle 200 to be washed, i.e., the image of the license plate number, and send it back to the control unit 50. The control unit 50 then recognizes the license plate number by means of license plate recognition and determines whether the license plate number exists in the database 51. If yes, the vehicle 200 to be washed is allowed to enter the car wash lane 10. At the same time, the license plate number is used to compare and read the corresponding vehicle type information of the database 51.

After the vehicle 200 is parked in the parking area 11, the positioning unit 30 senses the position of the wheels of the vehicle 200 through the sensing modules 31, thereby obtaining the parking data of the vehicle 200 in the parking area 11. Since the vehicle 200 may not be parked in the same position each time, the control unit 50 compares the parking data with the initial data of the vehicle type information, generates the compensation parameter from the deviation data, and adjusts the washing path D according to the compensation parameter.

Preferably, the control unit 50 controls the movement of the washing unit 40 for the camera module 45 to align with the reference feature of the vehicle 200 and capture the parking image of the vehicle 200 parked in the car wash lane 11. Then, the parking image is compared with the initial image of the vehicle type information to confirm whether there is any deviation. If yes, the deviation data is calculated to generate the secondary compensation parameter. The washing path D is readjusted based on the secondary compensation parameter.

Finally, the control unit 50 controls the washing unit 40 to move along the adjusted washing path D to wash the vehicle 200. The washing procedures are commonly known techniques, such as high-pressure water rinsing, cleaning solution spraying, brush scrubbing, liquid waxing and high-speed air drying, so the details will not be described here. The washing unit 40 uses the robotic arm 43 to wash the vehicle, so the flexibility of the robotic arm 43 can achieve the advantages of fast washing and the cleanliness and fineness of manual washing.

Thereby, the vehicle type information for each of common vehicles 200 on the market can be created in advance and stored in the database 51. The user can register the vehicle feature of his/her vehicle 200 and associate it with the corresponding vehicle type information. When the user drives the vehicle 200 into the car wash lane 10, the type of the vehicle can be automatically identified and the corresponding washing path D can be selected for washing the vehicle 200. Thus, the present invention can achieve the purpose of intelligent, manless and full-time automatic car wash and can wash any type of vehicles 200 fully, without dead spots, improving the cleanliness of washing car greatly.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An automatic car wash system, comprising:
at least one car wash lane, configured for one vehicle to pass and park;
a recognition unit, located close to the car wash lane for identifying the vehicle that is going to enter the car wash lane and obtaining a vehicle feature;
a positioning unit, located close to the car wash lane for locating the vehicle parked in the car wash lane to obtain parking data;
at least one washing unit, located close to the car wash lane and having a robot arm, the robot arm having a working end equipped with a washing structure for washing the vehicle;
a control unit, electrically connected to the recognition unit, the positioning unit and the washing unit, the control unit being further electrically connected to a database, the control unit selectively executing a modeling process and a washing process;
wherein when the vehicle is parked in the parking area and the modeling process is selected and executed, the parking data obtained by the positioning unit is set as initial data, the washing unit is pulled manually to move along a contour of the vehicle, a movement trajectory of the washing unit is recorded to generate a washing path, and the initial data and the washing path are integrated into vehicle type information to be stored in the database;
wherein when the vehicle is parked in the parking area and the washing process is selected and executed, the vehicle feature obtained by the recognition unit is compared with the database to determine whether there is the corresponding vehicle type information in the database, if yes, the corresponding vehicle type information is read, the parking data obtained by the positioning unit is compared with the initial data of the vehicle type information to generate a compensation parameter, the washing path is adjusted based on the compensation parameter, and the washing unit is controlled to move along the adjusted washing path to wash the vehicle.

2. The automatic car wash system as claimed in claim 1, wherein the recognition unit is a camera for obtaining the vehicle feature by means of image recognition.

3. The automatic car wash system as claimed in claim 2, wherein the vehicle feature is a license plate number, the license plate number is associated with the corresponding vehicle type information of the database, when the control unit executes the washing process, it determines and selects the vehicle type information based on the license plate number.

4. The automatic car wash system as claimed in claim 1, wherein the positioning unit has a plurality of sensing modules for obtaining the parking data by sensing the position of wheels of the vehicle.

5. The automatic car wash system as claimed in claim 1, wherein the washing unit further has a camera module for photographing the vehicle to obtain a parking image, when the control unit executes the modeling process, the parking image is set as an initial image and integrated into the vehicle type information, when the control unit executes the washing process, the parking image is compared with the initial image to generate a secondary compensation parameter for the control module to readjust the washing path based on the secondary compensation parameter, and the washing unit is controlled to move along the adjusted washing path to wash the vehicle.

6. The automatic car wash system as claimed in claim 1, wherein the washing structure has a body, the body has a plurality of spray holes, and the body further has a plurality of movable brushes.

7. An automatic car wash method, comprising the steps of:
creating vehicle type information for a plurality of vehicles of different types and storing the vehicle type information in a database, wherein the vehicle type information contains initial data of the position of the vehicle parked in a car wash lane, and a washing unit is pulled manually to move along a contour of the vehicle to generate a washing path;
creating a vehicle feature for each of the plurality of vehicles, wherein the vehicle feature is associated with the corresponding vehicle type information of the database;
wherein when the vehicle to be washed is going to enter the car wash lane, the vehicle feature of the vehicle to be washed is obtained, and the corresponding vehicle type information is compared and read from the database through the vehicle feature;
obtaining parking data of the vehicle parked in the car wash lane, comparing the parking data with the initial data of the vehicle type information to generate a compensation parameter;
adjusting the washing path of the vehicle type information based on the compensation parameter, and controlling the washing unit to move along the adjusted washing path to wash the vehicle to be washed.

8. The automatic car wash method as claimed in claim 7, wherein after obtaining the vehicle feature, it is determined whether the vehicle feature exists in the database, if yes, the vehicle to be washed is allowed to enter the car wash lane.

9. The automatic car wash method as claimed in claim 7, wherein the vehicle type information further contains an initial image of the vehicle parked in the car wash lane, after the washing path of the vehicle type information is adjusted based on the compensation parameter, a parking image of the vehicle parked in the car wash lane is obtained, the parking image is compared with the initial image to generate a secondary compensation parameter, after the washing path is readjusted based on the secondary compensation parameter, the washing unit is controlled to move along the adjusted washing path to wash the vehicle to be washed.

10. The automatic car wash method as claimed in claim 7, wherein the washing unit is a robot arm, the robot arm has a working end equipped with a washing structure, the washing structure has a body, the body has a plurality of spray holes, and the body further has a plurality of movable brushes.
